(19) United States
(12) Patent Application Publication
(10) Pub. No.: US 2023/0311449 A1
(43) Pub. Date: Oct. 5, 2023

(54) MULTI-LAYER BODY FOR DIFFUSE TRANSILLUMINATION

(71) Applicant: Covestro Deutschland AG, Leverkusen (DE)

(72) Inventors: Andreas Seidel, Dormagen (DE); Ciro Piermatteo, Leverkusen (DE); Rafael Oser, Krefeld (DE); Hans-Juergen Klankers, Leverkusen (DE); Jan Helmig, Dormagen (DE)

(21) Appl. No.: 18/043,762

(22) PCT Filed: Sep. 9, 2021
(86) PCT No.: PCT/EP2021/074751

§ 371 Date: Mar. 2, 2023

(30) Foreign Application Priority Data
Sep. 18, 2020 (EP) 20196826.0

(51) Int. Cl. B32B 7/023; B32B 27/36; B32B 27/08; B32B 27/30; B32B 27/18; F21V 9/08; C08L 69/00; C08J 5/18

(52) U.S. Cl. CPC B32B 7/023; B32B 27/365; B32B 27/08; B32B 27/308; B32B 27/18; F21V 9/08; C08L 69/00; C08J 5/18; B32B 2270/00; B32B 2264/0207; B32B 2307/4026; B32B 2307/412; B32B 2307/414; B32B 2307/7376; B32B 2255/10; B32B 2307/738; B32B 2250/02; B32B 2250/24; B32B 2264/0228; B32B 2274/00; B32B 2255/24; B32B 2457/20; B32B 2605/003; F21Y 2115/10

(57) ABSTRACT

The present invention relates to a multi-layer body comprising in this order, (I) a substrate layer made of a specific thermoplastic polycarbonate molding compound, (II) at least one layer made of a colorant or a colorant composition and (III) a film. The present invention also relates to a lighting unit, comprising the multi-layer body and a light source, to a method for producing the multi-layer body, and to the use of the specific thermoplastic polycarbonate molding compound as a substrate layer of a multi-layer body of this type.

The present invention relates to a multilayer article comprising in the following order a carrier layer composed of a thermoplastic polycarbonate molding compound, at least one layer of a colorant or a colorant composition and a film, to an illumination unit comprising the multilayer article and a light source, to a process for producing the multilayer article and to the use of a thermoplastic polycarbonate molding compound as the carrier layer of such a multilayer article.

Thermoplastic polycarbonate or polyestercarbonate molding compounds and compositions thereof have been known for many years and are described in numerous documents. The molding compounds are used to produce molded articles for example for the automotive sector, for the construction sector and for the electronics sector.

Ambient lighting elements or backlit functional/display elements are increasingly being used in automotive interiors and in automotive body applications. A market trend is to switch on/fade in the lighting or the display of functions only when required, for example in order to differentiate the appearance of such elements from day to night or to intensify the perception of space in the automotive interior using such ambient dynamic lighting or to allow needs-based and appropriate display of information.

Components suitable for such applications are, for example, multilayer articles comprising a carrier layer, a film transilluminable with light in the visible wavelength range and at least one layer of a colorant or a colorant composition (also referred to in the further context of the invention as the “colorant layer” for simplicity) arranged therebetween. The carrier layer and the film can be transilluminated with visible light (i.e. light in the wavelength range from 380 to 780 nm) using a light source, thus altering the appearance of the multilayer article in the desired fashion. It is possible to realize different appearances in day and night modes and in “on” and “off” mode via the coloration of the film and the colorant layer(s), via the transparency/opacity of the colorant layer(s) and via only partial application of the or certain colorant layer(s) in subregions between the film and the carrier layer. For example in day-mode the multilayer article may have an opaque, high-gloss appearance in any desired coloration and in night mode may be completely transilluminated or alternatively only partially transilluminated to display certain illumination patterns or logos. To this end in the regions in which no transillumination is desired in night mode or in the “on” display mode an opaque colorant layer is applied between the film and the carrier layer. In the regions in which transillumination is desired in night mode or in the “on” display mode either no colorant layer or a transilluminable colorant layer is applied between the film and the carrier layer. The desired coloration of the multilayer article in day mode or the “off” display mode and the desired coloration of the regions transilluminated in night mode or the “on” display mode may be realized via the coloration of either the film in these regions, the carrier layer and/or the colorant layer.

The carrier layer must exhibit a sufficient transmittance for the incident light in order to allow a particular appearance to be represented at all.

Multilayer articles having transilluminable, i.e. translucent or transparent layers, are known. WO2006/115851 A1 discloses multilayer articles comprising: (i) a first layer comprising an acrylic resin; (ii) at least one translucent second layer comprising (a) an acrylic resin optionally further comprising an impact modifier; (b) a rubber-modified thermoplastic resin composition; (c) optionally a rheology modifier and (d) a visual effects additive; (iii) a third layer comprising an acrylonitrile-butadiene-styrene (ABS) resin; and (iv) an optional carrier layer comprising either a thermoset, optionally fiber-reinforced, polymer substrate, or a glass-filled ABS resin.

For an appealing visual impression it is also often desirable for the carrier layer to scatter the light from a point light source, for example an LED, at least to a certain extent and thus distribute it diffusely onto the film. Otherwise, the light source would be visible to the observer and/or the desired visual effect upon activating the light source would be limited to only a small region of the multilayer article. To achieve such a diffuse light impression of a surface of the multilayer article transilluminated by a point light source it is necessary for the carrier layer on the one hand to have a highest possible transmittance of the incident of visible light and on the other hand to have a highest possible scattering-induced light diffusivity, i.e. a highest possible half power angle, of the light cone resulting from passage through the carrier layer of a point light source. The higher this half power angle, the more spatially homogeneous the perceived illumination intensity of the light emanating from a point light source after passing through the carrier layer. Higher half power angles of the carrier layer also allow larger areas to be transilluminated with a spatially largely homogeneous light intensity. Transmittance and light diffusivity (half power angle) of a material are generally not adjustable independently of one another and generally run counter to one another. Optimizing light diffusivity through material modification, for example by altering the composition thereof, generally results in decreasing transmittance. Both variables are in particular also dependent on the transilluminated material layer thickness, wherein with increasing layer thickness the transmittance of a translucent material decreases and the light diffusivity increases.

The multilayer articles may be produced by initially (partially) printing a transilluminable film with a colorant and subsequently subjecting said film to film insert molding with the carrier material. The process of film insert molding has been known for some years and is widely used.

Often employed carrier materials include for example polycarbonate molding compounds containing scattering particles such as for instance glass spheres, scattering pigments or other polymers having a refractive index distinct from that of polycarbonate. These polymers are often employed as crosslinked particles, often also for achieving improved compatibility with and dispersion in the polycarbonate matrix as a particulate graft polymer having a graft shell composed of a polymer compatible or partially compatible with polycarbonate (for example having a polymethyl methacrylate shell).

A disadvantage of such molding compounds is the high softening temperature of polycarbonate. In the production of multilayer articles a high processing temperature must therefore be selected to achieve a good flowability of the polycarbonate. This can result in damage to the film (for example in undesired deformation) or in inadequate or incomplete adhesion of the film to the carrier layer and to an irregular surface appearance of the multilayer article (so-called orange peel formation). This can also result in colorant being leaching out of the or one of the colorant layers with which the film has been printed. Such molding compounds further have a toughness which is inadequate for some applications, in particular at low temperatures. Use in some safety-relevant components is therefore out of the question.

The abovementioned problem of leaching is described in the literature, for example in EP1343844 B1 and DE 103 12 610. One way to avoid this phenomenon is to provide the printed film (decorative layer) with a protective layer so that the polymer melt does not directly contact the decorative layer. The protective layer may consist of polycarbonate for example and be applied by coextrusion for instance.

Alternatively, to avoid leaching, DE 103 12 610 A1 describes a process where a protective element in the form of a net, a woven fabric or a nonwoven fabric protects the decorative layer in the region of the entry opening of the polymer melt into the injection mold.

However, the described processes increase cost and complexity in terms of material inputs and process management in the production of the multilayer article.

To improve melt flowability—and thus achieve a reduction in the thermal stress on the colorant—polycarbonate may in principle be mixed with at least one further thermoplastic and processed into a polycarbonate blend molding compound.

The choice of blending partners and further components, for example additives, can be used to vary the profile of properties of the molding compound and of the molded articles in terms of rheological properties as well as mechanical and thermal characteristics to a large extent and match them to the demands of the respective application.

However, molded articles composed of polycarbonate blend molding compounds are generally opaque or insufficiently translucent, so that multilayer articles comprising such molding compounds are not suitable for meeting the abovementioned optical requirements.

It was therefore desirable to provide a multilayer article which allows the above-described dynamic illumination and/or fading in of functions. It was moreover desirable for the multilayer article to be simple to produce, i.e. for a stable laminate of the film and the carrier material to be achieved without the film being damaged, deformed or the colorant being leached out and without the process of film insert molding requiring particular process steps such as application of a protective means to the decorative film, particular process management or special apparatuses. It was therefore necessary for the carrier material to have a combination of good transmittance for visible light and high light diffusivity as well as being amenable to injection molding and bonding with the film at relatively low temperatures, i.e. having a high melt flowability/low melt viscosity even at low temperatures.

It was further desirable for the carrier material to have a high toughness, even at low temperatures and thus for the multilayer article to have a broad field of application, for example also to be suitable for safety components.

It has surprisingly been found that the abovementioned object is achieved by a multilayer article
comprising in the following order
   (I) a carrier layer composed of a thermoplastic molding compound
      A) at least one representative selected from the group consisting of aromatic polycarbonate and aromatic polyestercarbonate,
      B) rubber-modified vinyl (co)polymer composed of
         B.1) 80% to 95% by weight, based on the rubber-modified vinyl (co)polymer B, of structural units derived from at least one vinyl monomer and
         B.2) 5% to 20% by weight, based on the rubber-modified vinyl (co)polymer B, of one or more elastomeric graft substrates having glass transition temperatures<−50° C. and containing at least 50% by weight, based on B.2, of structural units derived from 1,3-butadiene,
         wherein the rubber-modified vinyl (co)polymer B contains
         (i) a disperse phase consisting of
         (i.1) rubber particles grafted with vinyl (co)polymer composed of structural units of B.1 and
         (i.2) vinyl (co)polymer likewise composed of structural units of B.1 enclosed in the rubber particles as a separate disperse phase and
         (ii) a rubber-free vinyl (co)polymer matrix consisting of structural units of B.1 which is not bonded to the rubber particles and is not enclosed in these rubber particles,
         wherein the disperse phase of (i) has a median diameter D50 measured by ultracentrifugation of 0.7 to 2.0 μm,
      C) optionally at least one further component selected from polymer additives and polymeric blend partners,
wherein the thermoplastic molding compound contains less than 2% by weight of rubber-based graft polymers distinct from component B) and
   wherein the thermoplastic molding compound has a rubber content of at least 1.5% by weight,
   (II) at least one layer consisting of a colorant or a colorant composition covering at least a portion of the area between the carrier layer and the film and
   (III) a film.

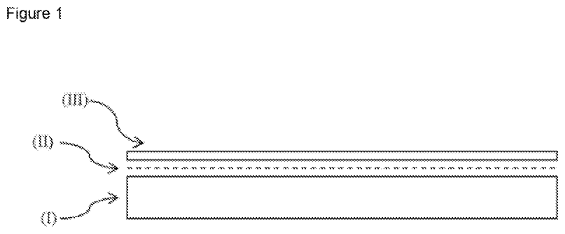

A multilayer article according to the invention is shown in schematic form in FIG. 1.

In a preferred embodiment the thermoplastic molding compound of the carrier layer (I) according to the invention contains
30% to 85% by weight, more preferably 50% to 82% by weight, yet more preferably 58% to 82% by weight, most preferably 65% to 75% by weight, of component A,
14% to 69% by weight, more preferably 17% to 49% by weight, yet more preferably 17% to 41% by weight, most preferably 24% to 34% by weight, of component B,
0.05% to 20% by weight, more preferably 0.1% to 10% by weight, yet more preferably 0.2% to 5% by weight, most preferably 0.3% to 2% by weight, of component C.

In a preferred embodiment the molding compound of the carrier layer (I) contains less than 1% by weight, more preferably less than 0.5% by weight, yet more preferably less than 0.2% by weight, of rubber-based graft polymers distinct from component B). The molding compound most preferably contains no rubber-based graft polymers distinct from component B).

In a preferred embodiment the molding compound of carrier layer (I) has a rubber content in the range from 1.5% to 6% by weight, more preferably in the range 1.8 to 5% by weight, yet more preferably in the range 1.9% to 4.1% by weight, most preferably in the range 2.5% to 3.0% by weight.

The aforementioned preferred ranges of components A and B and of component C may be combined with one another as desired.

In a preferred embodiment the carrier layer (I) consists of a thermoplastic molding compound consisting to an extent of at least 80% by weight, more preferably at least 95% by weight, more preferably at least 99% by weight and most preferably to an extent of 100% by weight, of the components A, B and C.

The multilayer article is suitable for transillumination with visible light using a light source, i.e. the multilayer article is preferably transilluminable. The light source is arranged such that the light is first incident on the carrier material (I) and finally reaches the film (III) through the layer (II). The light source is preferably an LED light source.

Transilluminable is to be understood as meaning that activation of the light source alters the visual impression on the side facing away from the light source.

In a preferred embodiment at least in subregions at its actual local thickness at at least one wavelength in the wavelength range of the spectrum from 380 to 780 nm the multilayer article according to the invention has a transmittance of at least 10%, more preferably at least 25%, yet more preferably at least 40% and most preferably of at least 45%, wherein the transmittance is obtained from the transmission spectrum measured according to the specification in DIN/ISO 13468-2, 2006 version.

The invention further provides for the use of a molding compound composed of the abovementioned components A, B and C and the further features specified as a carrier layer (I) in a multilayer article as described above.

The invention further provides an illumination unit comprising the multilayer article as specified above and a light source emitting light having at least one wavelength in the wavelength range of the spectrum from 380 to 780 nm, wherein the light source is arranged such that the carrier layer is transilluminated by the light emitted by the light source.

The invention further provides a process for producing a multilayer article, comprising the steps of:
a) producing a film
b) printing at least a portion of the film with at least one layer consisting of a colorant or a colorant composition,
c) optionally thermoforming the film
d) subjecting the film to insert molding with a thermoplastic molding compound as described above.

### Composition of the Carrier Layer

### Component A

Aromatic polycarbonates and/or aromatic polyestercarbonates of component A which are suitable in accordance with the invention are known from the literature or producible by processes known from the literature (for production of aromatic polycarbonates see, for example, Schnell, “Chemistry and Physics of Polycarbonates”, Interscience Publishers, 1964, and also DE-AS 1 495 626, DE-A 2 232 877, DE-A 2 703 376, DE-A 2 714 544, DE-A 3 000 610, DE-A 3 832 396; for production of aromatic polyestercarbonates, for example DE-A 3 007 934).

Aromatic polycarbonates are produced for example by reaction of diphenols with carbonyl halides, preferably phosgene and/or with aromatic dicarbonyl dihalides, preferably dihalides of benzenedicarboxylic acid, by the interfacial process, optionally using chain terminators, for example monophenols, and optionally using trifunctional or more than trifunctional branching agents, for example triphenols or tetraphenols. Production via a melt polymerization process by reaction of diphenols with for example diphenyl carbonate is likewise possible.

Diphenols for the production of the aromatic polycarbonates and/or aromatic polyestercarbonates are preferably those of formula (I)

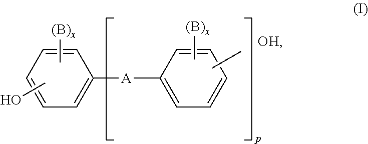

wherein
A is a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, onto which further aromatic rings optionally containing heteroatoms may be fused,
   or a radical of formula (II) or (III)

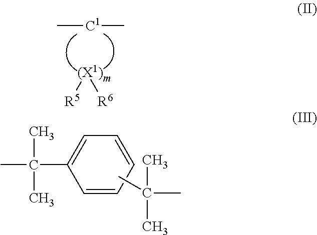

B is in each case C₁ to C₁₂-alkyl, preferably methyl, halogen, preferably chlorine and/or bromine,
x is independently at each occurrence 0, 1 or 2
p is 1 or 0, and
R⁵ and R⁶ are individually choosable for each X¹ and are independently of one another hydrogen or C₁ to C₆-alkyl, preferably hydrogen, methyl or ethyl,
X1 is carbon and
m is an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes and also ring-brominated and/or ring-chlorinated derivatives thereof.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxybiphenyl sulfide, 4,4′-dihydroxybiphenyl sulfone, and also the di- and tetrabrominated or chlorinated derivatives of these, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-Bis(4-hydroxyphenyl)propane (bisphenol A) is especially preferred.

The diphenols may be used individually or in the form of any desired mixtures. The diphenols are known from the literature or obtainable by literature processes.

Examples of chain terminators suitable for the production of the thermoplastic aromatic polycarbonates include phenol, p-chlorophenol, p-tert-butylphenol or 2,4,6-tribromophenol, and also long-chain alkylphenols such as 4-[2-(2,4,4-trimethylpentyl)]phenol, 4-(1,3-tetramethylbutyl)phenol according to DE-A 2 842 005 and monoalkylphenol or dialkylphenols having a total of from 8 to 20 carbon atoms in the alkyl substituents, for example 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol % based on the molar sum of the diphenols used in each case.

The thermoplastic aromatic polycarbonates have average molecular weights (weight-average M_{w}, measured by GPC (gel permeation chromatography) using a polycarbonate standard based on bisphenol A) of preferably 20 000 to 40 000 g/mol, more preferably 24 000 to 32 000 g/mol, particularly preferably 26 000 to 33 000 g/mol. The preferred ranges result in a particularly advantageous balance of mechanical and rheological properties in the compositions of the invention.

The thermoplastic aromatic polycarbonates may be branched in a known manner, and preferably through incorporation of 0.05 to 2.0 mol %, based on the sum total of the diphenols used, of trifunctional or more than trifunctional compounds, for example those having three or more phenolic groups. Preference is given to using linear polycarbonates, more preferably based on bisphenol A.

Both homopolycarbonates and copolycarbonates are suitable. Copolymers of the invention as per component A can also be produced using 1% to 25% by weight, preferably 2.5% to 25% by weight, based on the total amount of diphenols to be used, of polydiorganosiloxanes having hydroxyaryloxy end groups. These are known (U.S. Pat. No. 3,419,634) and may be produced by processes known from the literature. Likewise suitable are polydiorganosiloxane-containing copolycarbonates; production of the polydiorganosiloxane-containing copolycarbonates is described in, for example, DE-A 3 334 782.

Aromatic dicarbonyl dihalides for production of aromatic polyestercarbonates are preferably the diacyl dichlorides of isophthalic acid, of terephthalic acid, of diphenyl ether 4,4′-dicarboxylic acid and of naphthalene-2,6-dicarboxylic acid.

Particular preference is given to mixtures of the diacyl dichlorides of isophthalic acid and of terephthalic acid in a ratio between 1:20 and 20:1.

Production of polyestercarbonates additionally makes concomitant use of a carbonyl halide, preferably phosgene, as the bifunctional acid derivative.

Chain terminators contemplated for the production of the aromatic polyestercarbonates are not only the abovementioned monophenols but also the chlorocarbonic esters of these, and also the acyl chlorides of aromatic monocarboxylic acids, which can optionally have substitution by C₁ to C₂₂-alkyl groups or by halogen atoms; aliphatic C₂ to C₂₂-monocarbonyl chlorides can also be used as chain terminators here.

The amount of chain terminators in each case is 0.1 to 10 mol %, based on moles of diphenol in the case of the phenolic chain terminators and on moles of dicarbonyl dichloride in the case of monocarbonyl chloride chain terminators.

One or more aromatic hydroxycarboxylic acids may also be used in the production of aromatic polyestercarbonates.

The aromatic polyestercarbonates may be either linear or branched in a known manner (see DE-A 2 940 024 and DE-A 3 007 934), preference being given to linear polyestercarbonates.

Branching agents that may be used are for example tri- or polyfunctional carbonyl chlorides, such as trimesoyl trichloride, cyanuroyl trichloride, 3,3′,4,4′-benzophenonetetracarbonyl tetrachloride, 1,4,5,8-naphthalenetetracarbonyl tetrachloride or pyromellitoyl tetrachloride, in amounts of 0.01 to 1.0 mol % (based on dicarbonyl dichlorides employed) or tri- or polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy)methane, 1,4-bis[4,4′-dihydroxytriphenyl)methyl]benzene, in amounts of 0.01 to 1.0 mol % based on diphenols employed. Phenolic branching agents may be initially charged together with the diphenols; acid chloride branching agents may be introduced together with the acid dichlorides.

The proportion of carbonate structural units in the thermoplastic aromatic polyestercarbonates may be varied as desired. The proportion of carbonate groups is preferably up to 100 mol %, in particular up to 80 mol %, particularly preferably up to 50 mol %, based on the sum of ester groups and carbonate groups. Both the ester fraction and the carbonate fraction of the aromatic polyestercarbonates may be present in the form of blocks or in random distribution in the polycondensate.

The thermoplastic aromatic polycarbonates and polyestercarbonates may be used alone or in any desired mixture.

It is preferable to employ linear polycarbonate based on exclusively bisphenol A as component A.

### Component B

Component B is selected from rubber-modified vinyl (co)polymers of
B.1) 80% to 95% by weight, preferably 83% to 93% by weight, more preferably 85% to 92% by weight, based on the rubber-modified vinyl (co)polymer B, of structural units derived from at least one vinyl monomer and
B.2) 5% to 20% by weight, preferably 7% to 17% by weight, more preferably 8% to 15% by weight, based on the rubber-modified vinyl (co)polymer B, of one or more elastomeric graft substrates having glass transition temperatures T_{g}
<−50° C., preferably of <−60° C., particularly preferably <−70° C., containing at least 50% by weight, preferably at least 70% by weight, particularly preferably 100% by weight, based on B.2, of structural units derived from 1,3-butadiene,
   wherein the rubber-modified vinyl (co)polymer B contains
   (i) a disperse phase consisting of
      (i.1) rubber particles grafted with vinyl (co)polymer composed of structural units of B.1 and
      (i.2) vinyl (co)polymer likewise composed of structural units of B.1 enclosed in the rubber particles as a separate disperse phase and
   (ii) a rubber-free vinyl (co)polymer matrix consisting of structural units of B.1 which is not bonded to the rubber particles and is not enclosed in these rubber particles,
      and wherein the disperse phase of (i) has a median diameter D50 measured by ultracentrifugation of 0.7 to 2.0 m, preferably of 0.7 to 1.5 m, in particular of 0.7 to 1.2.

Unless expressly stated otherwise in the present invention the glass transition temperature T_{g} is determined for all components by dynamic differential scanning calorimetry (DSC) according to DIN EN 61006 (1994 version) at a heating rate of 10 K/min with determination of Tg as the midpoint temperature (tangent method).

The rubber-modified vinyl (co)polymers of component B have a melt volume flow rate (MVR) measured according to ISO 1133 (2012 version) at 220° C. with a piston load of 10 kg of preferably 2 to 20 ml/10 min, particularly preferably 3 to 15 ml/10 min, especially 4 to 8 ml/10 min. If mixtures of two or more rubber-modified vinyl (co)polymers are employed as component B the preferred MVR ranges apply to the average of the MVR of the individual components weighted by the mass fractions of the components in the mixture.

Such rubber-modified vinyl (co)polymers B are produced for example by free-radical polymerization, preferably in a bulk polymerization process, of
B.1 80% to 95% by weight, preferably 83% to 93% by weight, particularly preferably 85% to 92% by weight, based on the rubber-modified vinyl (co)polymer B, of at least one vinyl monomer in the presence of
B.2 5% to 20% by weight, preferably 7% to 17% by weight, particularly preferably 8% to 15% by weight, based on the rubber-modified vinyl (co)polymer B, of one or more elastomeric graft substrates having glass transition temperatures
<−50° C., preferably <−60° C., particularly preferably <−70° C., and containing at least 50% by weight, preferably at least 70% by weight, particularly preferably 100% by weight, based on B.2 of structural units derived from 1,3-butadiene.

The bulk polymerization reaction preferably used for producing the rubber-modified vinyl (co)polymer B comprises both the polymerization of the vinyl monomers of B.1 and a grafting of the thus formed vinyl (co)polymer onto the elastomeric graft substrate of B.2. Furthermore, in this reaction regime self-organization (phase separation) results in formation of a disperse phase (i) consisting of
(i.1) rubber particles grafted with vinyl (co)polymer composed of structural units of B.1 and
(i.2) vinyl (co)polymer likewise composed of structural units of B.1 enclosed in the rubber particles as a separate disperse phase,
   wherein this rubber-containing phase (i) is in the form of a dispersion in a rubber-free vinyl (co)polymer matrix (ii) not bonded to the rubber particles and not enclosed in these rubber particles and consisting of structural units of B.1.

In contrast to the other vinyl (co)polymer proportions in the component B the rubber-free vinyl (co)polymer (ii) may be dissolved out using suitable solvents such as acetone for example.

The size of the disperse phase (i) in the thus produced rubber-modified vinyl (co)polymers B is adjusted via the conditions of the reaction regime such as temperature and the viscosity of the polymer resulting therefrom and also shear from stirring for example.

The median particle size D50 is the diameter with 50% by weight of the particles above it and 50% by weight below it. Unless expressly stated otherwise in the present invention it is determined for all components by ultracentrifuge measurement (W. Scholtan, H. Lange, Kolloid, Z. und Z. Polymere 250 (1972), 782-796).

The monomers B.1 are preferably mixtures consisting of
B.1.1 60 to 85 parts by weight, particularly preferably 65 to 80 parts by weight, more preferably 70 to 78 parts by weight, in each case based on the sum of B.1.1 and B.1.2 of styrene and
B.1.2 15 to 40 parts by weight, particularly preferably 20 to 35 parts by weight, more preferably 22 to 30 parts by weight, in each case based on the sum of B.1.1 and B.1.2 of acrylonitrile
   and optionally B.1.3 0-10 parts by weight, preferably 0-7 parts by weight, more preferably 0-5 parts by weight, of methyl methacrylate or n-butyl acrylate in each case based on 100 parts by weight as the sum of B.1.1 and B.1.2.

In a further preferred embodiment the monomers B.1 are a mixture of 22 to 26 parts by weight of acrylonitrile and 74 to 78 parts by weight of styrene, which optionally can contain up to 10 parts by weight, particularly preferably up to 5 parts by weight, of n-butyl acrylate or methyl methacrylate, wherein the parts by weight of styrene and acrylonitrile sum to 100 parts by weight.

It is particularly preferable when B.1 is free from B.1.3, wherein the abovementioned preferred ranges apply to B.1.1 and B.1.2.

Preferred graft substrates B.2 are diene rubbers containing butadiene or mixtures of diene rubbers containing butadiene or copolymers of diene rubbers containing butadiene or mixtures thereof with further copolymerizable monomers (for example of B.1.1 and B.1.2).

A particularly preferred graft substrate B.2 is pure polybutadiene rubber. In a further preferred embodiment B.2 is styrene-butadiene block copolymer rubber.

Component B preferably has a polybutadiene content of 5% to 18% by weight, more preferably of 7% to 15% by weight, in particular of 8% to 13% by weight.

Particularly preferred rubber-modified vinyl (co)polymers of component B are bulk-polymerized ABS polymers as described for example in DE-A 2 035 390 (=U.S. Pat. No. 3,644,574) or in DE-A 2 248 242 (=GB-B 1 409 275), or in Ullmanns Enzyklopädie der Technischen Chemie, Vol. 19 (1980), p. 280 ff.

The vinyl (co)polymer (ii) not chemically bonded to the rubber substrate(s) B.2 and not enclosed in the rubber particles may be formed as described above as a consequence of production in the polymerization of the graft polymers B. It is likewise possible for a portion of this vinyl (co)polymer (ii) not chemically bonded to the rubber substrate(s) B.2 and not enclosed in the rubber particles to be formed in the rubber-modified vinyl (co)polymer of component B as a consequence of production in the production thereof in the bulk polymerization process and for another portion to be polymerized separately and added to the component B as a constituent of component B. In component B the proportion of the vinyl (co)polymer (ii), irrespective of origin, measured as the acetone-soluble proportion is preferably at least 50% by weight, particularly preferably at least 60% by weight, more preferably at least 70% by weight, based on component B.

In the rubber-modified vinyl (co)polymers of component B this vinyl (co)polymer (ii) has a weight-average molecular weight M_{w} of 70 to 250 kg/mol, preferably of 130 to 200 kg/mol, in particular of 150 to 180 kg/mol.

In the context of the present invention the weight-average molecular weight M_{w} of the vinyl (co)polymer (ii) in component B is measured by gel permeation chromatography (GPC) in tetrahydrofuran against a polystyrene standard.

The component B is preferably free from alkali metal, alkaline earth metal, ammonium or phosphonium salts of saturated fatty acids having 8 to 22 carbon atoms, resin acids, alkyl- and alkylarylsulfonic acids and fatty alcohol sulfates.

Component B preferably contains less than 100 ppm, particularly preferably less than 50 ppm, very particularly preferably less than 20 ppm, of ions of alkali metals and alkaline earth metals.

Rubber-modified vinyl (co)polymers suitable as component B are for example Magnum™ 3404, Magnum™ 3504 and Magnum™ 3904 from Trinseo S.A. (Luxemburg).

### Component C

Component C present may optionally be one or more representatives selected from the group consisting of polymer additives and polymeric blend partners.

The polymer additives/polymeric blend partners are preferably selected from the group consisting of lubricants and mold release agents, stabilizers, colorants, compatibilizers, further impact modifiers distinct from component B, further polymeric constituents (for example functional blend partners or graft polymers having a core-shell structure produced in an emulsion polymerization process) distinct from the components A and B and fillers and reinforcers.

In a preferred embodiment component no fillers or reinforcers are present in component C. It is further preferable when no colorants are present. It is further preferable when no polymeric blend partners are present. It is further preferable when no polymeric components are present. In a particularly preferred embodiment no fillers or reinforcers, colorants or polymeric blend partners are present. It is most preferable when no fillers or reinforcers, colorants or polymeric components are present.

In a preferred embodiment at least one polymer additive selected from the group consisting of lubricants and mold release agents and stabilizers is employed as component C.

In a preferred embodiment at least one representative selected from the group consisting of sterically hindered phenols, organic phosphites and organic or inorganic Brönstedt acids is employed as a stabilizer.

In a preferred embodiment at least one representative selected from the group consisting of sterically hindered phenols, organic phosphites and organic or inorganic Brönstedt acids is employed as a stabilizer.

In a preferred embodiment fatty acid esters, particularly preferably fatty acid esters of pentaerythritol or glycerol, are employed as lubricants and mold release agents.

In a particularly preferred embodiment at least one polymer additive selected from the group consisting of C8-C22 fatty acid esters of pentaerythritol, C8-C22 fatty acid esters of glycerol, tris(2,4-di-tert-butylphenyl)phosphite, 2,6-di-tert-butyl-4-(octadecanoxycarbonylethyl)-phenol, tetrakis(2,4-di-tert-butylphenyl)-4,4-biphenyldiphosphonite, bis(2,4-di-tert-butylphenyl)pentaerythritol diphosphite and triethylene glycol bis[3-(3-tert-butyl-4-hydroxy-5-methylphenyl)propionate] is employed as component C.

In a further embodiment the component C contains no rubber-modified vinyl (co)polymer produced by emulsion polymerization.

### Production of the Molding Compounds of the Carrier Layer

Thermoplastic molding compounds are produced from the components A, B and C according to the invention.

The thermoplastic molding compounds according to the invention may be produced for example when the respective constituents of the compositions are in familiar fashion mixed and melt-compounded and melt-extruded at temperatures of preferably 200° C. to 320° C., particularly preferably at 240° C. to 300° C., very particularly preferably at 260° C. to 290° C., in customary apparatuses such as internal kneaders, extruders and twin-screw extruders for example.

In the context of the present application this process is generally referred to as compounding.

The term “molding compound” is thus to be understood as meaning the product obtained when the constituents of the composition are melt-compounded and melt-extruded.

The mixing of the individual constituents of the compositions may be carried out in a known manner, either successively or simultaneously, either at about 20° C. (room temperature) or at a higher temperature. This means that, for example, some of the constituents may be introduced via the main intake of an extruder and the remaining constituents may be introduced later in the compounding process via a side extruder.

### Colorant Composition

Decoration of the film employs the colorant composition customary for the respective processes, for example screen printing inks, color coats or inks.

The colorant compositions according to the invention contain at least one colorant as a necessary component. The term colorant is to be understood as meaning organic and inorganic pigments and dyes including soluble dyes.

One or more further components which may be roughly categorized as volatile and nonvolatile components may also be present.

The nonvolatile components include binders, fillers and auxiliaries. Auxiliaries are typically required only in very small amounts but are often indispensable for problem-free processing.

The volatile constituent are essentially liquids in which the colorants and any other constituents are dissolved or dispersed. These may be organic or inorganic solvents or mixtures of two or more solvents. The solvent is often water or a mixture of water and another solvent.

Suitable organic solvents include for example ketones, esters, alcohols and aromatic or aliphatic hydrocarbons. It is also possible to use mixtures of two or more organic or inorganic solvents.

The nonvolatile binders ensure that the colorants are anchored to the substrate in order that the finished print can withstand stresses due to abrasion, heat and mechanical bending.

Suitable binders for the colorants include for example nitrocellulose in combination with plasticizers, thermoplastic polyurethanes, thermoplastic polyesters, thermoplastic polycarbonates and thermoplastic poly(meth)acrylates. It is also possible to combine different binders, as described in DE 198 32 570 A1. It is also possible to form the binder (for example a polyurethane or an epoxy resin) in situ by chemical reaction during application of the colorant composition.

The selection of suitable dyes is practically unlimited provided a sufficient temperature resistance is ensured. Suitable organic colorants include, for example, colorants from the azo, anthraquinone, azoporphine, thioindigo, dioxazine, naphthalenetetracarboxylic acid or perylenetetracarboxylic acid series and phthalocyanine compounds. Suitable inorganic colorants include, for example, iron oxides, ultramarines, zinc sulfides, silicon dioxides, aluminum oxides, titanium oxides, nickel and chromium compounds, phosphotungstic-molybdic acid bronzes and carbon blacks. Special effect colorants, for instance metal oxide-coated mica pigments and metallic aluminum pigments, may likewise be used.

A filler may also be incorporated into the color and composition if required. Suitable fillers include carbonates, sulfates, silicates and oxides.

Well-suited fillers include magnesium, calcium and barium carbonate, calcium and barium sulfate, silicates and aluminosilicates as well as aluminum, titanium and silicon oxide. Mixtures of these compounds may also be employed.

Customary and well-known auxiliaries may also be incorporated into the colorant composition. Such auxiliaries include, for example, wetting and dispersing auxiliaries, anti-settling agents, leveling agents, adhesion promoters, stabilizers, scratchproofing additives and the like.

Production of the coating composition from the employed components is carried out by mixing the components using a process known to those skilled in the art such as for example dispersing, dissolving or compounding in the melt

Particularly heat-resistant colorant compositions are described in EP 0688839 A2 for example. Heat-resistant colorant compositions are also available from Proll KG, Weißenburg, Germany under the designation Noriphan® HTR.

However, the present invention is not limited to very heat resistant colorant compositions. As described in the introduction the inventive choice of the carrier material with good melt flowability even at low processing temperatures also makes it possible to employ in the production of multilayer articles colorant compositions that are more sensitive to high temperatures and have thus not hitherto been suitable for prior art production of multilayer articles by film insert molding.

Colorants that are particularly suitable for screen printing of PMMA films are described in DE 101 51 281 A1.

In the production of the multilayer article according to the invention a portion or the total amount of the volatile components present in the colorant composition may escape and thus be a constituent of the current composition according to component II of the claimed multilayer article only to a small extent, if at all.

The colorant composition applied to the film may be transparent, translucent or opaque to visible light. If the colorant composition is opaque then the colorant composition is not printed on the entire film the region to be transilluminated. This makes it possible to fade in display elements for example.

It is also possible for different film regions to be printed with different colorant compositions or for a plurality of layers of different colorant compositions to be printed on top of one another.

A preferred embodiment here is overlayed printing of transilluminable, i.e. transparent or translucent colorant compositions with opaque colorant compositions. It is particularly preferable when these two colorant compositions have the same or a similar coloration.

### Film

The film may be a single-ply film or a multi-ply film.

The one or more further layers in the multi-ply construction may have been applied for example by coextrusion, lamination and/or coating processes, such as wet-coating processes or plasma-coating processes.

The film is preferably a film composed of a thermoplastic composition containing one or more thermoplastic polymers and optionally further additives. Customary polymer additives may be added as additives. The thermoplastic composition may in particular be colored by suitable colorants.

Thermoplastic polymers include for example thermoplastic polyurethanes, polymethyl methacrylate (PMMA) and modified variants of PMMA, polyolefins, aromatic polycarbonate (PC), also including copolycarbonate (Co-PC), polyetherimide, styrene-acrylonitrile, acrylonitrile-styrene-acrylic ester copolymers (ASA), acrylonitrile-butadiene-styrene copolymers (ABS), polyester and mixtures of these polymers.

The material for the film is preferably selected from thermoplastic polymers based on polycarbonate.

In an alternative preferred embodiment the film is selected from thermoplastic polymers based on polymethyl methacrylate.

The term “based on” is here to be understood as meaning that the proportion of the polymer in the total composition of the film is at least 60% by weight, preferably at least 75% by weight, more preferably at least 90% by weight.

In a preferred embodiment the film is transilluminable in its entirety. The definition of the term transilluminable is elucidated hereinabove.

It is possible that only portions of the film are transilluminated by a light source. This may be achieved for example by using a film composed of two or more plies. In this case one of the plies may have a high transmission for visible light (i.e. light in the wavelength range of the spectrum from 380 to 780 nm) and a further ply may be opaque but provided with holes, slots or similar apertures for the light. In such a construction only the portions of the film where the opaque ply has an aperture for the light are transilluminable.

The film is transilluminable for visible light in the region to be transilluminated in its actually employed thickness. In the context of the present invention the term “transilluminable” is preferably to be understood as referring to films which at least in the regions to be transilluminated by the light source at at least one wavelength in the visible wavelength range of the spectrum (380 bis 780 nm) have a transmittance of at least 20%, more preferably at least 50%, particularly preferably at least 70% determined according to the specification in DIN/ISO 13468-2 (2006 version, (light source: D65, observer: 10°)).

In a preferred embodiment the entire film has a visual transmittance of at least 20%, preferably at least 50%, particularly preferably at least 70%, determined according to DIN/ISO 13468-2 (2006 version, (light source: D65, observer: 10°)).

It is most preferable when the film moreover has a yellowness value as a measure of color neutrality, measured according to ASTM E313 (2010 version), of at most 20, preferably at most 5, particularly preferably at most 2.

The thickness of the film is 50 μm to 1 mm, preferably 100 μm to 700 μm. This is to be understood as meaning that the film has this thickness at every point over its extent.

The film may be coated with a coating composition on the side facing away from the carrier layer. A coating is typically intended to provide mechanical protection from abrasion and scratching and/or protection from weathering effects, i.e. precipitation, temperature variation and UV radiation. Specific surface haptics or optics can also be achieved with a coating.

Suitable coatings are for example thermally curable coating systems based on a polysiloxane coating which may be either single-layer or multi-layer systems (with a merely adhesion-promoting primer layer between the substrate and the polysiloxane topcoat).

It is also possible to employ UV-curable coating systems, based on acrylate, urethane acrylate or acryloylsilane for example and optionally including fillers for improving scratch resistance.

It is also possible for the coating and/or the film itself to contain colorants as specified above.

For example, the thermoplastic composition that the film is composed of may contain such colorants. In such cases, the film itself is then colored throughout. An opaque colorant composition may then be applied to portions of the area between the film and the carrier material as layer (II) for example.

If the coating of the film contains colorants then it is possible to select these from colorants having a low temperature resistance as well as from the abovementioned colorants.

If the coating of the film or the thermoplastic composition that the film is composed of contains colorants these colorants are of such a nature and used in such a concentration that the transilluminability of the film is still ensured. This is to be understood as meaning that the coloration of the coating on the side facing away from the carrier layer and the film itself are not opaque.

### Production of the Multilayer Articles

The multilayer articles are preferably produced by the FIM process (film insert molding). Film insert molding (FIM) is a special injection molding process where optionally three-dimensionally pre-formed films are inserted as inserts into the injection mold before injection of the plastic belt. The process as such is known to those skilled in the art and is widely used.

The inserts are usually formed, optionally decorated films. Forming may be effected using mechanical or contactless thermoforming. This employs deep-drawing for example. Other processes are vacuum deep drawing, pressing or blow molding. At tighter positional tolerances the known high pressure forming (HPF) process, as described for example in EP 2 197 656 B1, is used. The films are generally trimmed after forming. This may employ common processes such as stamping, milling, knife cutting, laser cutting and water jet cutting.

Put simply, in a preferred process production of the multilayer articles according to the invention thus preferably comprises the steps of:
a) printing the film with the colorant composition,
b) optionally forming and optionally subsequently cutting the film
c) subjecting the film to insert molding with molten molding compound of the carrier layer in an injection mold.

It is also possible for the three-dimensional forming of the film and the insert molding of the film to be carried out in a single injection mold. Such a simplified m process is described for example in WO 2014/044694 A1.

The printing of the films may be performed with various printing processes, for instance screen printing, offset printing and digital printing by xerography or inkjet printing.

Other possible processes for printing the film are painting, pad printing, relief printing (incl. flexo), planographic printing and intaglio printing.

The method employed depends inter alia on the print substrate, the component shape, requirements of print quality and the filter.

Digital printing allows colored printing without first requiring printing mold or plate. The digitalized print data are passed directly to a digital printing machine. This process enables fast on-demand printing and high flexibility in the run including down to single runs. The two most important digital printing technologies are xerography and inkjet printing. The digitized information is especially printed by xerography which is similar to color laser copying. A further process for printing digital information is inkjet printing. This uses high-precision microjets to fire ink directly onto the surface to be printed. The inks should be selected such that they effect good wetting of the film surface and adhere securely thereto.

Due to its high print speed offset printing is particularly suitable for economic production of large quantities (print runs) and is used to produce very fine line patterns for example.

It is preferable to use screen printing as the printing process. Screen printing affords printed images of high opacity and color density. This is important for transmitted light applications in which printed films are backlit, for example in automotive components having a day/night design such as dials or decorative illumination elements.

The printed design may be for example a company emblem, a vehicle type or vehicle class designation, a piece of text or a purely decorative pattern.

It is also possible that after subjection of the film to insert molding with the carrier material a further layer of the carrier material is applied in an overmolding process, so that this further layer seamlessly envelops the surface of the component obtained after the insert molding. Overmolding is known to those skilled in the art and is described for example in the published specifications WO 2012/069590 A1, EP2402140 A1 and DE 102007011338 A1.

In a further preferred embodiment an outer film is optionally additionally applied to the plastic article in addition to the film of component III. It is preferable when this outer film is applied to the side which later in the installed state of the multilayer article according to the invention in its end use is on the side facing the observer. In a more preferred embodiment the outer film is a hard coating film, also referred to as a hardcoated film.

The thickness of the carrier layer I is preferably 0.5 to 10 mm, more preferably 1 to 5 mm. This is to be understood as meaning that the carrier layer I has this thickness at every point over its extent. The layer formed directly by subjecting the film to insert molding need not necessarily have the same thickness over the entire area of the film but rather may also have different thicknesses, for example due to the configuration of reinforcing ribs, due to the component shape or due to mounting structures etc.

In the region to be transilluminated the carrier layer I preferably has a thickness of 0.5 mm to 5 mm, particularly preferably of 1.5 mm to 3.5 mm, particularly preferably of 1.7 mm to 2.5 mm.

Further embodiments 1 to 40 of the present invention are described hereinbelow:
1. Multilayer article
comprising in the following order
   (I) a carrier layer composed of a thermoplastic molding compound containing
      A) at least one representative selected from the group consisting of aromatic polycarbonate and aromatic polyestercarbonate,
      B) rubber-modified vinyl (co)polymer composed of
      B.1) 80% to 95% by weight, based on the rubber-modified vinyl (co)polymer B, of structural units derived from at least one vinyl monomer and
      B.2) 5% to 20% by weight, based on the rubber-modified vinyl (co)polymer B, of one or more elastomeric graft substrates having glass transition temperatures<−50° C. and containing at least 50% by weight, based on B.2, of structural units derived from 1,3-butadiene,
         wherein the rubber-modified vinyl (co)polymer B contains
         (i) a disperse phase consisting of
         (i.1) rubber particles grafted with vinyl (co)polymer composed of structural units of B.1 and
         (i.2) vinyl (co)polymer likewise composed of structural units of B.1 enclosed in the rubber particles as a separate disperse phase
         and
         (ii) a rubber-free vinyl (co)polymer matrix consisting of structural units of B.1 which is not bonded to the rubber particles and is not enclosed in these rubber particles,
         wherein the disperse phase of (i) has a median diameter D50 measured by ultracentrifugation of 0.7 to 2.0 μm,
      C) optionally at least one further component selected from polymer additives and polymeric blend partners,
   wherein the thermoplastic molding compound contains less than 2% by weight of rubber-based graft polymers distinct from component B) and
   wherein the thermoplastic molding compound has a rubber content of at least 1.5% by weight,
   (II) at least one layer consisting of a colorant or a colorant composition covering at least a portion of the area between the carrier layer and the film and
   (III) a film.
2. Multilayer article according to embodiment 1, wherein the film is transilluminable.
3. Multilayer article according to embodiment 1 or 2, wherein the film is composed of a thermoplastic material.
4. Multilayer article according to any of the preceding embodiments, wherein the film consists to an extent of at least 60% by weight of methyl methacrylate.
5. Multilayer article according to any of embodiments 1 to 3, wherein the film consists to an extent of at least 60% by weight of polycarbonate.
6. Multilayer article according to any of the preceding embodiments, wherein the thickness of the film is in the range from 50 m to 1 mm at every point.
7. Multilayer article according to any of the preceding embodiments, wherein the thickness of the film is in the range from 100 to 700 μm at every point.
8. Multilayer article according to any of the preceding embodiments, wherein the film in its actually employed thickness in the region to be transilluminated at at least one wavelength in the wavelength range of the spectrum from 380 to 780 nm has a transmittance of at least 20% determined according to the specification in DIN/ISO 13468-2 (2006 version).
9. Multilayer article according to any of the preceding embodiments, wherein the film in its actually employed thickness in the region to be transilluminated at at least one wavelength in the wavelength range of the spectrum from 380 to 780 nm has a transmittance of at least 50% determined according to the specification in DIN/ISO 13468-2 (2006 version).
10. Multilayer article according to any of the preceding embodiments, wherein the film in its actually employed thickness in the region to be transilluminated at at least one wavelength in the wavelength range of the spectrum from 380 to 780 nm has a transmittance of at least 70% determined according to the specification in DIN/ISO 13468-2 (2006 version).
11. Multilayer article according to any of the preceding embodiments, wherein the thickness of carrier layer at every point is in the range 1 to 5 mm.
12. Multilayer article according to any of the preceding embodiments, wherein the carrier layer has a thickness of 1.5 to 3.7 mm in the region to be transilluminated.
13. Multilayer article according to any of the preceding embodiments, wherein in subregions of the area between the carrier layer (I) and the film (III) the multilayer article comprises a light transmittance-reducing layer composed of a colorant or a colorant composition and in these regions the multilayer article has a visual transmittance of at most 10% determined according to DIN/ISO 13468-2, 2006 version, with a D65 light source and an angle to the observer of 100.
14. Multilayer article according to any of the preceding embodiments, wherein in subregions of the area between the carrier layer (I) and the film (III) the multilayer article comprises a light transmittance-reducing layer composed of a colorant or a colorant composition and in these regions the multilayer article has a visual transmittance of at most 25% determined according to DIN/ISO 13468-2, 2006 version, with a D65 light source and an angle to the observer of 100.
15. Multilayer article according to any of the preceding embodiments, wherein in subregions of the area between the carrier layer (I) and the film (III) the multilayer article comprises a light transmittance-reducing layer composed of a colorant or a colorant composition and in these regions the multilayer article has a visual transmittance of at most 45% determined according to DIN/ISO 13468-2, 2006 version, with a D65 light source and an angle to the observer of 100.
16. Multilayer article according to any of the preceding embodiments, wherein the carrier layer comprises
30% to 85% by weight of component A, 14% to 69% by weight of component B and 0.05% to 20% by weight of component C.
17. Multilayer article according to any of the preceding embodiments, wherein the carrier layer comprises 50% to 82% by weight of component A, 17% to 49% by weight of component B and 0.1% to 10% by weight of component C.
18. Multilayer article according to any of the preceding embodiments, wherein the carrier layer comprises 58% to 82% by weight of component A, 17% to 41% by weight of component B and 0.2% to 5% by weight of component C.
19. Multilayer article according to any of the preceding embodiments, wherein the carrier layer comprises 65% to 75% by weight of component A, 24% to 34% by weight of component B and 0.3% to 2% by weight of component C.
20. Multilayer article according to any of the preceding embodiments, wherein the carrier layer contains less than 1% by weight of rubber-based graft polymers distinct from component B).
21. Multilayer article according to any of the preceding embodiments, wherein the carrier layer contains less than 0.5% by weight of rubber-based graft polymers distinct from component B).
22. Multilayer article according to any of the preceding embodiments, wherein the carrier layer contains less than 0.2% by weight of rubber-based graft polymers distinct from component B).
23. Multilayer article according to any of the preceding embodiments, wherein the carrier layer contains no rubber-based graft polymers distinct from component B) whatsoever.
24. Multilayer article according to any of the preceding embodiments, wherein the carrier layer has a rubber content in the range from 1.5% to 6% by weight.
25. Multilayer article according to any of the preceding embodiments, wherein the carrier layer has a rubber content in the range from 1.8% to 5% by weight.
26. Multilayer article according to any of the preceding embodiments, wherein the carrier layer has a rubber content in the range from 1.9% to 4.1% by weight.
27. Multilayer article according to any of the preceding embodiments, wherein the carrier layer has a rubber content in the range from 2.5% to 3.0% by weight.
28. Multilayer article according to any of the preceding embodiments, wherein component A of the carrier layer is an aromatic polycarbonate exclusively based on bisphenol A.
29. Multilayer article according to any of the preceding embodiments, wherein component B of the carrier layer is produced by a bulk polymerization process.
30. Multilayer article according to any of the preceding embodiments, wherein component B contains less than 100 ppm of ions of alkali metals and alkaline earth metals.
31. Multilayer article according to any of the preceding embodiments, wherein component B contains less than 20 ppm of ions of alkali metals and alkaline earth metals.
32. Multilayer article according to any of the preceding embodiments, wherein the carrier layer consists to an extent of at least 80% by weight of the components A, B and C.
33. Multilayer article according to any of the preceding embodiments, wherein the carrier layer consists to an extent of at least 95% by weight of the components A, B and C.
34. Multilayer article according to any of the preceding embodiments, wherein the carrier layer consists to an extent of at least 99% by weight of the components A, B and C.
35. Multilayer article according to any of the preceding embodiments, wherein the carrier layer consists of the components A, B and C.
36. Multilayer article according to any of the preceding embodiments, wherein the multilayer article is transilluminable.
37. Use of a thermoplastic molding compound containing the components A, B and C as described in any of the preceding embodiments 1 and 16 to 36
   as a carrier layer in a multilayer article,
   wherein the multilayer article comprises the following components in the following order:
      (I) the carrier layer,
      (II) at least one layer consisting of a colorant or a colorant composition covering at least a portion of the area between the carrier layer and the film and
      (III) a film.
38. Process for producing a multilayer article
comprising the steps of
   a) producing a film
   b) printing at least a portion of the film with at least one layer consisting of a colorant or a colorant composition,
   c) optionally thermoforming the film
   d) subjecting the film to insert molding with a thermoplastic molding compound containing the components A, B and C as described in any of the preceding embodiments 1 and 16 to 36.
39. Lighting unit comprising
   a) a multilayer article according to any of embodiments 1 to 36
   b) a light source emitting light having at least one wavelength in the wavelength range of the spectrum from 380 to 780 nm,
   wherein the light source is arranged such that the carrier layer is transilluminated by the light emitted by the light source.
40. Lighting unit according to embodiment 39, wherein the light source is an LED light source.

### EXAMPLES

### Component A-1:

Linear polycarbonate based on bisphenol A having a weight-average molecular weight M_{w} of 24 000 g/mol (determined by GPC at room temperature in methylene chloride against a BPA-PC standard).

### Component A-2:

Linear polycarbonate based on bisphenol A having a weight-average molecular weight M_{w} of 28 000 g/mol (determined by GPC at room temperature in methylene chloride against a BPA-PC standard).

### Component B-1:

Acrylonitrile-butadiene-styrene (ABS) polymer produced in a bulk polymerization process which contains a disperse phase composed of styrene-acrylonitrile copolymer-grafted rubber particles based on a polybutadiene rubber as the graft substrate and containing enclosed styrene-acrylonitrile copolymer as a separate disperse phase and a styrene-acrylonitrile copolymer matrix which is not chemically bonded to the rubber particles and not enclosed in the rubber particles. Component B-1 has an A:B:S ratio of 23:10:67% by weight and a gel content, determined as the proportion insoluble in acetone, of 20% by weight. The acetone-soluble proportion of component B-1 has a weight-average molecular weight M_{w} (measured by GPC in tetrahydrofuran as the solvent using a polystyrene standard) of 165 kg/mol. The median particle size of the disperse phase D50, measured by ultracentrifugation, is 0.85 μm. The melt volume flow rate (MVR) of component B-1, measured according to ISO 1133 (2012 version) at 220° C. with a piston load of 10 kg, is 6.7 ml/10 min.

### Component B-2:

Acrylonitrile-butadiene-styrene (ABS) polymer produced in a bulk polymerization process which contains a disperse phase composed of styrene-acrylonitrile-n-butyl acrylate terpolymer-grafted rubber particles based on a polybutadiene rubber as the graft substrate and containing enclosed styrene-acrylonitrile-n-butyl acrylate terpolymer as a separate disperse phase and a styrene-acrylonitrile copolymer matrix which is not chemically bonded to the rubber particles and not enclosed in the rubber particles. Component B-2 has an A:B:S:BA ratio of 22.5:10:63:4.5% by weight and a gel content, determined as the proportion insoluble in acetone, of 19% by weight. The acetone-soluble proportion of component B-2 has a weight-average molecular weight M_{w} (measured by GPC in tetrahydrofuran as the solvent using a polystyrene standard) of 115 kg/mol. The median particle size of the disperse phase D50, measured by ultracentrifugation, is 0.50 μm. The melt flow rate (MFR) of component C-1, measured to ISO 1133 (2012 version) at 220° C. with a ram load of 10 kg, is 28 g/10 min.

### Component B-3

Acrylonitrile-butadiene-styrene graft polymer having a core-shell structure produced by emulsion polymerization of 43% by weight, based on the ABS polymer, of a mixture of 27% by weight of acrylonitrile and 73% by weight of styrene in the presence of 57% by weight, based on the ABS polymer, of a particulate-crosslinked polybutadiene rubber as the graft substrate. This polybutadiene rubber graft substrate has a bimodal particle size distribution having maxima at 0.28 μm and 0.40 μm and an average particle size D50, measured by ultracentrifugation, of 0.35 μm.

Component B-3 contains no styrene-acrylonitrile copolymer enclosed in the rubber particles.

### Component B-4

Acrylonitrile-butadiene-styrene graft polymer having a core-shell structure produced by emulsion polymerization of 42% by weight, based on the ABS polymer, of a mixture of 26% by weight of acrylonitrile and 74% by weight of styrene in the presence of 58% by weight, based on the ABS polymer, of an agglomerated particulate polybutadiene rubber as the graft substrate. Compared to the graft substrate used in component B-3, this polybutadiene rubber graft subtrate has a significantly broader and monomodal particle size distribution. However, the average particle size D50, measured by ultracentrifugation, of 0.38 μm is in a similar range to that of component B-3.

Component B-4 contains no styrene-acrylonitrile copolymer enclosed in the rubber particles.

### Component B-5

Styrene-acrylonitrile copolymer produced in a bulk polymerization process having an acrylonitrile content of 23% by weight and having a weight-average molecular weight M_{w} of 100 000 Da measured by GPC at room temperature in tetrahydrofuran with a polystyrene standard.

### Component C1:

### Pentaerythritol Tetrastearate

### Component C-2:

Irganox™ B900 (BASF, Ludwigshafen, Germany)

Mixture of 80% by weight of tris(2,4-di-tert-butyl-phenyl) phosphite (Irgafos™ 168) and 20% by weight of 2,6-di-tert-butyl-4-(octadecanoxycarbonylethyl)phenol (Irganox™ 1076)

### Component C3:

Irganox™ 1076 (BASF, Ludwigshafen, Germany)

2,6-di-tert-butyl-4-(octadecanoxycarbonylethyl)phenol

### Production and Testing of the Molding Compounds According to the Invention

Production of the molding compound was carried out in a ZSK25 twin-screw extruder from Coperion, Werner & Pfleiderer (Stuttgart, Germany) at a melt temperature of 260° C. and with application of a reduced pressure of 100 mbar (absolute).

The molded articles were produced at a melt temperature of 260° C. and a mold temperature of 80° C. in an Arburg 270 E injection molding machine.

Melt viscosity was determined at a temperature of 260° C. and a shear rate of 1000 s⁻¹ according to ISO 11443 (2014 version).

The IZOD notched impact strength was determined at temperatures in the range from −50° C. to 23° C. on test bars having dimensions of 80 mm×10 mm×4 mm according to ISO 180/U (2013 version). The measurements at different temperatures were used to determine the ductile-brittle transition temperature as the temperature at which 50% of the test specimens in the test undergo brittle breakage and 50% undergo ductile breakage.

To determine material ductility under multiaxial stress at low temperatures a puncture test according to ISO 6603-2 (2002 version) was performed at −20° C. on in each case ten test specimens having dimensions of 60 mm×60 mm×2 mm. The percentage of brittle fractures serves as a measure of the material ductility under multiaxial stress. A brittle fracture is to be understood as meaning a fracture failure in which parts of the test specimen splinter out during the puncture test and/or the test specimens show unstable crack propagation causing the test specimen to break completely in two along such a crack in the test.

Modulus of elasticity E and elongation at break were determined on dumbbells having dimensions of 170 mm×10 mm×4 mm at 23° C. according to ISO 527 (1996 version) at a strain rate of 1 mm/min (modulus of elasticity) or 5 mm/min (elongation at break).

As a measure of heat resistance the Vicat B/120 softening temperature is determined on test bars having dimensions of 80 mm×10 mm×4 mm according to ISO 180/1A (2014 version).

As a measure of transilluminability the total transmittance was determined according to ISO 13468-2 (2006 version) (light source: D65, observer: 10°) on test specimens having dimensions of 60 mm×40 mm×2 mm (i.e. at a material thickness of 2 mm).

The half power angle (HPA) of the light intensity was used as a measure for light diffusivity. Greater half power angles mean stronger light scattering. The half power angle is determined by measuring the intensity of the light after transillumination of a test specimen having dimensions of 60 mm×40 mm by 2 mm (i.e. having a material thickness of 2 mm) as a function of the polar angle measured relative to the incident light beam in the range from 0° to 90°. The obtained values are normalized to the intensity value measured at an angle of 0°, so that the normalized intensity varies between 0 and 1 as a function of the polar angle θ, where I(0°)=1. The half power angle (HPA) is defined as the angle at which the normalized intensity has dropped to 0.5, i.e. I(HPA)=0.5. According to this definition the theoretical maximum possible half power angle is 60°.

TABLE 1
Compositions and properties thereof

| | 1 | V2 | V3 | V4 | V5 | V6 | 7 | 8 | V9 | 10 | 11 | 12 | V13 |
|---|---|---|---|---|---|---|---|---|---|---|---|---|---|
| Component | | | | | | | | | | | | | |
| A-1 | 80 | 80 | 80 | 80 | 80 | 80 | 60 | 70 | 90 | | | | |
| A-2 | | | | | | | | | | 60 | 70 | 80 | 90 |
| B-1 | 20 | | | | | | 40 | 30 | 10 | 40 | 30 | 20 | 10 |
| B-2 | | 20 | | | | | | | | | | | |
| B-3 | | | 5 | 2.5 | | | | | | | | | |
| B-4 | | | | | 5 | 2.5 | | | | | | | |
| B-5 | | | 15 | 17.5 | 15 | 17.5 | | | | | | | |
| C-1 | 0.5 | 0.5 | 0.5 | 0.5 | 0.5 | 0.5 | 0.5 | 0.5 | 0.5 | 0.5 | 0.5 | 0.5 | 0.5 |
| C-2 | 0.1 | 0.1 | 0.1 | 0.1 | 0.1 | 0.1 | 0.1 | 0.1 | 0.1 | 0.1 | 0.1 | 0.1 | 0.1 |
| C-3 | 0.2 | 0.2 | 0.2 | 0.2 | 0.2 | 0.2 | 0.2 | 0.2 | 0.2 | 0.2 | 0.2 | 0.2 | 0.2 |
| Calculated | | | | | | | | | | | | | |
| parameter | | | | | | | | | | | | | |
| Rubber | 2.0 | 2.0 | 2.8 | 1.4 | 2.9 | 1.4 | 4.0 | 3.0 | 1.0 | 4.0 | 3.0 | 2.0 | 1.0 |
| content in | | | | | | | | | | | | | |
| composition | | | | | | | | | | | | | |
| [% by wt.] | | | | | | | | | | | | | |
| Properties | | | | | | | | | | | | | |
| Transmittance | 52 | 46 | 46 | 51 | 44 | 49 | 47 | 49 | 60 | 46 | 48 | 52 | 58 |
| [%] | | | | | | | | | | | | | |
| Half power | 50 | 24 | 3 | 2 | 34 | 2 | 57 | 55 | 2 | 56 | 55 | 50 | 2 |
| angle [°] | | | | | | | | | | | | | |
| Melt viscosity | 248 | 200 | 228 | 213 | 228 | 225 | 174 | 202 | 312 | 204 | 230 | 293 | 454 |
| [Pas] | | | | | | | | | | | | | |
| Notched | 21 | 16 | 15 | 10 | 15 | 9 | 20 | 24 | 13 | 43 | 43 | 27 | 13 |
| impact | | | | | | | | | | | | | |
| strength | | | | | | | | | | | | | |
| at −30° C. | | | | | | | | | | | | | |
| [kJ/m²] | | | | | | | | | | | | | |
| Ductile- | 0 | 10 | 15 | >23 | 15 | >23 | −15 | −25 | >23 | −45 | −35 | −25 | >23 |
| brittle | | | | | | | | | | | | | |
| transition | | | | | | | | | | | | | |
| temperature | | | | | | | | | | | | | |
| [° C.] | | | | | | | | | | | | | |
| Puncture | 70 | 100 | 100 | 100 | 70 | 70 | 90 | 50 | 20 | 0 | 0 | 80 | 80 |
| test [% | | | | | | | | | | | | | |
| brittle | | | | | | | | | | | | | |
| fracture] | | | | | | | | | | | | | |
| Modulus of | 2325 | 2426 | 2432 | 2529 | 2410 | 2524 | 2289 | 2307 | 2341 | 2273 | 2310 | 2348 | 2356 |
| elasticity | | | | | | | | | | | | | |
| Elongation | 60 | 101 | 54 | 57 | 59 | 52 | 62 | 59 | 53 | 53 | 85 | 94 | 86 |
| at break | | | | | | | | | | | | | |
| Vicat B120 | 135 | 134 | 135 | 134 | 135 | 134 | 124 | 131 | 138 | 123 | 131 | 136 | 138 |

The data in table 1 show that the inventive molding compounds which contain as component B the inventive component B-1 and are in the inventive range in terms of the polybutadiene rubber content exhibit a surprisingly advantageous combination of high light transmittance and high light diffusivity (scattering power). The inventive molding compounds moreover exhibit an advantageous combination of improved melt flowability (reduced melt viscosity) and good mechanical properties, in particular a good material toughness even at low temperatures. By contrast, the noninventive molding compounds containing the noninventive emulsion-polymerized ABS components B-3 or B-4 or a noninventive bulk-polymerized ABS component B-2 fail to meet this technical object of the invention. The same applies to the molding compounds composed of compositions V9 and V13 which are outside the inventive range in terms of their content of polybutadiene rubber.

A multilayer article according to the invention is shown in schematic form in FIG. 1.

1: A multilayer article comprising in the following order
(I) a carrier layer composed of a thermoplastic molding compound containing
A) at least one representative selected from the group consisting of aromatic polycarbonate and aromatic polyestercarbonate,
B) rubber-modified vinyl (co)polymer composed of
B.1) 80% to 95% by weight, based on the rubber-modified vinyl (co)polymer B, of structural units derived from at least one vinyl monomer and
B.2) 5% to 20% by weight, based on the rubber-modified vinyl (co)polymer B, of one or more elastomeric graft substrates having glass transition temperatures<−50° C. and containing at least 50% by weight, based on B.2, of structural units derived from 1,3-butadiene,
wherein the rubber-modified vinyl (co)polymer B contains
(i) a disperse phase consisting of
(i.1) rubber particles grafted with vinyl (co)polymer composed of structural units of B.1 and
(i.2) vinyl (co)polymer likewise composed of structural units of B.1 enclosed in the rubber particles as a separate disperse phase
and
(ii) a rubber-free vinyl (co)polymer matrix consisting of structural units of B.1 which is not bonded to the rubber particles and is not enclosed in these rubber particles,
wherein the disperse phase of (i) has a median diameter D50 measured by ultracentrifugation of 0.7 to 2.0 μm,
C) optionally at least one further component selected from polymer additives and polymeric blend partners,
wherein the thermoplastic molding compound contains less than 2% by weight of rubber-based graft polymers distinct from component B) and wherein the thermoplastic molding compound has a rubber content of at least 1.5% by weight,
(II) at least one layer consisting of a colorant or a colorant composition covering at least a portion of the area between the carrier layer and the film and
(III) a film.

2: The multilayer article according to claim 1, wherein the film is transilluminable.

3: The multilayer article according to claim 1, wherein the film is composed of a thermoplastic material.

4: The multilayer article according to claim 1, wherein the film consists of at least 60% by weight of methyl methacrylate.

5: The multilayer article according to claim 1, wherein the film consists of at least 60% by weight of polycarbonate.

6: The multilayer article according to claim 1, wherein the thickness of the film is 50 m to 1 mm.

7: The multilayer article according to claim 1, wherein the thickness of the carrier layer is from 1 to 5 mm.

8: The multilayer article according to claim 1, wherein in subregions of the area between the carrier layer (I) and the film (III) the multilayer article comprises a light transmittance-reducing layer (II) comprised of a colorant or a colorant composition and in these regions the multilayer article has a visual transmittance of at most 10% determined according to DIN/ISO 13468-2, 2006 version, with a D65 light source and an angle to the observer of 10°.

9: The multilayer article according to claim 1, wherein the carrier layer contains
30% to 85% by weight of component A,
14% to 69% by weight of component B,
and 0.05% to 20% by weight of component C.

10: The multilayer article according to claim 1, wherein the carrier layer has a rubber content of 1.9% to 4.1% by weight.

11: The multilayer article according to claim 1, wherein component B of the carrier layer is produced by a bulk polymerization process.

12: The use of a thermoplastic molding compound containing
A) at least one representative selected from the group consisting of aromatic polycarbonate and aromatic polyestercarbonate,
B) rubber-modified vinyl (co)polymer composed of
B.1) 80% to 95% by weight, based on the rubber-modified vinyl (co)polymer B, of structural units derived from at least one vinyl monomer and
B.2) 5% to 20% by weight, based on the rubber-modified vinyl (co)polymer B, of one or more elastomeric graft substrates having glass transition temperatures<−50° C. and containing at least 50% by weight, based on B.2, of structural units derived from 1,3-butadiene,
wherein the rubber-modified vinyl (co)polymer B contains
(i) a disperse phase consisting of
(i.1) rubber particles grafted with vinyl (co)polymer composed of structural units of B.1, and
(i.2) vinyl (co)polymer likewise composed of structural units of B.1 enclosed in the rubber particles as a separate disperse phase and
(ii) a rubber-free vinyl (co)polymer matrix consisting of structural units of B.1 which is not bonded to the rubber particles and is not enclosed in these rubber particles,
wherein the disperse phase of (i) has a median diameter D50 measured by ultracentrifugation of 0.7 to 2.0 μm,
C) optionally at least one further component selected from polymer additives and polymeric blend partners
wherein the thermoplastic molding compound contains less than 2% by weight of rubber-based graft polymers distinct from component B) and wherein the thermoplastic molding compound has a rubber content of at least 1.5% by weight, as a carrier layer in a multilayer article, and
wherein the multilayer article comprises the following components in the following order:
(I) the carrier layer,
(II) at least one layer consisting of a colorant or a colorant composition covering at least a portion of the area between the carrier layer and the film and
(III) a film.

13: A process for producing a multilayer article comprising the steps of
a) producing a film
b) printing at least a portion of the film with at least one layer consisting of a colorant or a colorant composition,
c) optionally thermoforming the film
d) subjecting the film to insert molding with a thermoplastic molding compound containing
A) at least one representative selected from the group consisting of aromatic polycarbonate and aromatic polyestercarbonate,
B) rubber-modified vinyl (co)polymer composed of
B.1) 80% to 95% by weight, based on the rubber-modified vinyl (co)polymer B, of structural units derived from at least one vinyl monomer and
B.2) 5% to 20% by weight, based on the rubber-modified vinyl (co)polymer B, of one or more elastomeric graft substrates having glass transition temperatures<−50° C. and containing at least 50% by weight, based on B.2, of structural units derived from 1,3-butadiene,
wherein the rubber-modified vinyl (co)polymer B contains
(i) a disperse phase consisting of
(i.1) rubber particles grafted with vinyl (co)polymer composed of structural units of B.1 and
(i.2) vinyl (co)polymer likewise composed of structural units of B.1 enclosed in the rubber particles as a separate disperse phase and
(ii) a rubber-free vinyl (co)polymer matrix consisting of structural units of B.1 which is not bonded to the rubber particles and is not enclosed in these rubber particles,
wherein the disperse phase of (i) has a median diameter D50 measured by ultracentrifugation of 0.7 to 2.0 μm,
C) optionally at least one further component selected from polymer additives and polymeric blend partners,
wherein the thermoplastic molding compound contains less than 2% by weight of rubber-based graft polymers distinct from component B) and wherein the thermoplastic molding compound has a rubber content of at least 1.5% by weight.

14: A lighting unit comprising
a) a multilayer article according to claim 1,
b) a light source emitting light having at least one wavelength in the wavelength range of the spectrum from 380 to 780 nm,
wherein the light source is arranged such that the carrier layer is transilluminated by the light emitted by the light source.

15: The lighting unit according to claim 14, wherein the light source is an LED light source.
